(19) United States
(12) Patent Application Publication
(10) Pub. No.: US 2009/0167193 A1
(43) Pub. Date: Jul. 2, 2009

(54) IMAGE-PROCESSING EQUIPMENTS, IMAGE-PROCESSING METHOD, PROGRAM, AND RECORDING MEDIUM

(75) Inventors: Masakazu Ogasawara, Osaka (JP); Takaaki Gyoten, Hyogo (JP)

Correspondence Address: RATNERPRESTIA, P.O. BOX 980, VALLEY FORGE, PA, 19482, US

(73) Assignee: PANASONIC CORPORATION, OSAKA (JP)

(21) Appl. No.: 12/299,941

(22) PCT Filed: Nov. 27, 2007
(86) PCT No.: PCT/JP2007/072859

§ 371 Date: Nov. 7, 2008

(30) Foreign Application Priority Data
Nov. 29, 2006 (JP) 2006-321483

(51) Int. Cl. H05B 37/02

(52) U.S. Cl. 315/151

(57) ABSTRACT

An image display apparatus which represents a grayscale by pulse-width modulation driving of a display element includes: a light source which illuminates the display element; a light source driving part which drives the light source; a photodetector which detects the emission intensity of light emitted from the light source; a sample-and-holder which obtains the emission intensity of the light source by the photodetector at a predetermined timing in a light emission period of the light source; and a compensation current generating part which (i) obtains the manner in which the emission intensity of the light source changes on the basis of a first sample value obtained at a first timing by the sample-and-holder and of a second sample value obtained at a second timing by the sample-and-holder or a predetermined target value of the emission intensity; and (ii) controls the light source driving part for compensating the emission intensity of the light source on the basis of the obtained manner in which the emission intensity changes.

This application is a U.S. National Phase Application of PCT International Patent Application No. PCT/JP2007/072859 filed on Nov. 27, 2007, claiming the benefit of priority of Japanese Patent Application No. 2006-321483 filed on Nov. 29, 2006, all of which are incorporated by reference herein in their entirety.

### TECHNICAL FIELD

The present invention relates to an image display apparatus having an illuminating light source which stabilizes the output from the light source by feedback control, an image display method, a program, and a recording medium.

### BACKGROUND ART

Image display apparatuses such as projectors are beginning to use high-intensity light emitting diodes (LEDs), instead of conventional lamps, as the illuminating light sources in order to expand the range of color reproduction. Unlike lamps, semiconductor light sources such as the LEDs have luminescence emission spectra that characteristically concentrate in a relatively narrow range. Therefore, semiconductor light sources having three luminescent colors, R (Red), G (Green), and B (Blue), are combined and used as an illuminating light source in many cases.

However, it is known that the light outputs of such a semiconductor light source changes depending on changes in the ambient temperature, changes in the temperature of the light source itself, or driving conditions, that is, the amount of driving current. The term light outputs here refers to the quantity of light, that is, brightness, and the dominant wavelength. As these factors change, the brightness of the entire screen or the chromaticity and luminance of the primary colors change, and color temperature, namely white balance changes. Therefore, a photodetector is used to detect the quantity of light and feedback control is performed to stabilize the quantity of light, thereby stabilizing especially white balance (see for example Japanese Patent Laid-Open No. 2001-332764).

The entire disclosure of Japanese Patent Laid-Open No. 2001-332764 is incorporated herein by reference in its entirety.

The block diagram in FIG. 9 shows a configuration of such a conventional image display apparatus.

A signal processing part 66 in FIG. 9 performs image signal processing on an input image signal 106, such as conversion to a signal format suitable for a display element. A display element drive control part 65 generates a signal that drives a reflective display element 64 in accordance with an output from the signal processing part 66.

The reflective display element 64 is an element, such as a DMD (Digital Micromirror Device), that changes the length of time each pixel of light emitted from a light source 58 is reflected to a screen (not shown) in accordance with grayscale brightness to represent. That is, the reflective display element 64 is a display element that represents a grayscale by pulse-width modulation driving and represents the grayscale by changing the length of time a mirror that the display element has for each pixel is in the on or off state.

A projection lens 67 projects light reflected by the reflective display element 64 to the screen. The light source 58 emits illuminating light to illuminate the reflective display element 64. For illustrative purposes, an example in which only one light source is used is shown in FIG. 9.

Many of the conventional image display apparatuses use three types of illuminating light sources, which are one or more light sources each emitting R-light, G-light, and B-light. The three light source systems have the same configuration and therefore only one system will be described in the description of the exemplary conventional image display apparatus.

A photodetector 59 is a photodetector that converts the quantity of light to an electrical signal, which may be a photosensor having photodiodes and color filters attached to the photodiodes, for example. The quantity of light of the light source 58 is detected with the photodetector 59 and a light quantity detection output 105 according to the quantity of light is output as a voltage.

A sample-and-holder (S/H) 62 samples and holds the signal voltage level of the light quantity detection output 105 in response to a sampling pulse 109 output from a timing signal generating part 82 in order to obtain the signal voltage level of the light quantity detection output 105.

The timing signal generating part 82 also generates a light source drive timing signal 110 that causes the light source 58 to emit light. The light source drive timing signal 110 also acts as a timing signal for allowing the display element drive control part 65 to synchronize driving of the display element with light emission from the light source.

An analog-digital converting part (A/D) 61 converts an output from the sample-and-holder (S/H) 62 to a digital signal and outputs a sample value 107.

An error detecting part 80 extracts an error between a sample value 107 of the quantity of light and a predetermined target value 100.

A drive control part 81, in response to an error component output from the error detecting part 80, changes a light source driving current gain for a light source driving part 57 in the direction in which the difference between the quantity of light of the light source 58 and a predetermined quantity of light (target value 100) decreases, that is, in the direction predetermined brightness is maintained.

The light source driving part 57 generates a driving current that drives the light source 58 in accordance with a light source driving current gain output from the drive control part 81.

In this way, the conventional image display apparatus compares the quantity of emitted light with the predetermined quantity of light on the basis of the light quantity detection output 105 output from the photodetector 59 and performs feedback operation for changing the light source driving current in the direction in which the difference between them decreases, that is, in the direction predetermined brightness is maintained.

The feedback operation will be described in further detail with respect to a waveform chart in FIG. 10.

When the light quantity detection output 105 output from the photodetector 59 is obtained as a waveform as shown in FIG. 10 (a), sampling is performed in that light emission period in response to a sampling pulse 109. If the resulting sample value 107 is lower than the target value 100, the light source driving current is controlled by the feedback operation so as to increase.

When the quantity of light of the light source 58 changes with ambient temperature or with time, the quantity of light emitted from the light source 58 is maintained at a constant level as a result of the operation described above.

FIG. 10 (b) shows a more realistic state.

Once the light emission period is entered, the light source driving current increases and hence the temperature of the light source increases. However, the temperature of the light source does not instantly rise to a constant value but instead rises in an ascending curve as shown in FIG. 10 (b). Since the luminous efficiency of the light source 58 decreases with the increasing temperature, the light quantity detection output 105 does not become constant in the light emission period but gradually decreases as shown in FIG. 10 (b) and is detected as a slope of the quantity —of light (temporal change in the quantity of light will be referred to as “slope of the quantity of light” herein) in the light quantity detection output 105. A sample value 107 is obtained at the timing of the sampling pulse 109 even in such a case and the error between the sample value 107 and the target value 100 raises the light source driving current.

While the operation in a single system has been described in the foregoing description, the feedback operation described above is performed similarly in an image display apparatus having multiple light sources.

### DISCLOSURE OF THE INVENTION

### Problems to be Solved by the Invention

However, the conventional image display apparatus has a problem that the continuity of the grayscale is impaired (it is sometimes referred to as “the continuity of the grayscale is impaired” herein if the grayscale does not stably changes) when a light source that has the time-decreasing characteristic (the characteristic is referred to as “slope characteristic” herein) that is detected as a light quantity detection output 105 as shown in FIG. 10 (b) is used as light illuminating the reflective display element 64. The problem will be described with reference to a diagram in FIG. 11 showing the relationship between grayscale level and slope.

The reflective display element 64 represents a grayscale by pulse-width modulation driving as described above. For ease of explanation, a case will be described in which an 8 grayscale levels from black to white are represented by using 3 bits.

Periods A, B, and C in FIG. 11 have time widths of 1:4:2. By turning on or off the mirrors of the reflective display element 64 for the time widths of the periods, the 8 levels of grayscale, 0 (black state) and 1 to 7, can be represented by combinations of the three periods.

However, it is obvious that, when the quantity of light is sloped as a result of a decrease in luminous efficiency due to a temperature rise of the light source in a light emission period as described above, the quantity of light of light reflected on the screen decreases by that slope as compared with the quantity of light without a slope.

FIG. 11 shows results of calculation of the quantity of light with slope at the grayscale levels in percentages, where 100% represents the quantity of light without slope at each level of the grayscale. The slope of the light quantity is linear and the amount of decrease is 10%.

As can be seen from FIG. 11, the percentage varies depending on the grayscale levels. That is, there is a problem that each level of the grayscale does not match a predetermined grayscale level (this problem is described as “the continuity of the grayscale is impaired” herein).

In view of the problem with the conventional image display apparatuses, it is an object of the present invention to provide an image display apparatus, an image display method, a program, and a recording medium capable of achieving grayscale levels closer to predetermined grayscale levels even when a temporal change in the quantity of light occurs in a light emission period.

### Means for Solving the Problems

The 1^{st} aspect of the present invention is an image display apparatus which represents a grayscale by pulse-width modulation driving of a display element, comprising:

a light source unit which illuminates said display element;

a light source unit driving part which drives said light source unit;

a photodetector which detects emission intensity of light emitted from said light source unit;

a sampler which obtains said emission intensity of said light source unit by said photodetector at a predetermined timing in a light emission period of said light source unit; and

a compensation control unit which (i) obtains a manner in which the emission intensity of said light source unit changes, on the basis of a first sample value obtained at a first timing by said sampler and of a second sample value obtained at a second timing by said sampler or a predetermined target value of said emission intensity; and (ii) controls said light source unit driving part for compensating the emission intensity of said light source unit, on the basis of said obtained manner in which said emission intensity changes.

The 2^{nd} aspect of the present invention is the image display apparatus according to the 1^{st} aspect of the present invention, wherein said compensation control unit obtains the manner in which said emission intensity changes, on the basis of said first and second sample values.

The 3^{rd} aspect of the present invention is the image display apparatus according to the 2^{nd} aspect of the present invention, wherein obtaining the manner in which said emission intensity changes means that a linear characteristic corresponding to a change in said emission intensity is obtained by using linear interpolation on the basis of a difference between said first and second sample values or a correspondent quantity corresponding to said difference and of information concerning a time difference between said first and second timings; and

said compensation control unit obtains a quantity of compensation for compensating said emission intensity on the basis of said obtained linear characteristic and said target value.

The 4^{th} aspect of the present invention is the image display apparatus according to the 3^{rd} aspect of the present invention, wherein said linear characteristic is equivalent to a straight line passing through two points identified on the basis of said sample values and said timings or to a straight line that is in correspondence relationship with said straight line.

The 5^{th} aspect of the present invention is the image display apparatus according to the 3^{rd} aspect of the present invention, wherein said linear characteristic is equivalent to a slope amount of a straight line identified on the basis of a difference between said first and second sample values or a correspondent quantity corresponding to said difference and of information concerning a time difference between said first and second timings or is equivalent to a slope amount that is in a correspondence relationship with said slope amount; and

said compensation control unit considers said emission intensity at the starting time of said emission period as said target value and obtains said quantity of compensation on the basis of said identified slope amount.

The 6^{th} aspect of the present invention is the image display apparatus according to the 4^{th} aspect of the present invention, wherein said compensation control unit comprises:

an error detection unit which uses all or a part of a plurality of said sample values obtained at different timings by said sampler to detect a difference between at least said first and second sample values; and

a light source unit control part which controls an electric current in said light source unit driving part for compensating the emission intensity of said light source unit on the basis of a result of detection by said error detection unit and information concerning said time difference.

The 7^{th} aspect of the present invention is the image display apparatus according to the 3^{rd} aspect of the present invention, wherein said compensation control unit comprises:

a plurality of error detecting parts which detect a difference from said target value at each of a plurality of said samplings by said sampler;

a plurality of drive control parts which generate a light source driving current gain for causing the emission intensity of said light source unit to approach said target value on the basis of values detected by said plurality of error detecting parts; and

a compensation current generating part which obtains a difference component of a light source driving current gain of each of said plurality of drive control parts as said correspondent quantity and generates a compensation current for compensating for a change in the emission intensity of said light source unit from said obtained difference component.

The 8^{th} aspect of the present invention is the image display apparatus according to the 7^{th} aspect of the present invention, wherein said light source unit comprises red, green, and blue light emitting diodes.

The 9^{th} aspect of the present invention is the image display apparatus according to the 1^{st} aspect of the present invention, wherein said compensation control unit obtains the manner in which said emission intensity changes, on the basis of said first sample value and said predetermined target value of said emission intensity.

The 10^{th} aspect of the present invention is the image display apparatus according to the 9^{th} aspect of the present invention, wherein obtaining the manner in which said emission intensity changes means that said emission intensity at the starting time of said light emission period is considered as said target value and a linear characteristic corresponding to a change in said emission intensity is obtained by using linear interpolation on the basis of said target value and said first sample value; and

said compensation control unit obtains a quantity of compensation for compensating said emission intensity on the basis of said obtained linear characteristic and said target value.

The 11^{th} aspect of the present invention is the image display apparatus according to the 10^{th} aspect of the present invention, wherein said linear characteristic is equivalent to a straight line passing through two points identified on the basis of said emission intensity at said starting time and said first sample value and of said starting timing and said first timing or is equivalent to a straight line that is in a correspondence relationship with said straight line.

The 12^{th} aspect of the present invention is the image display apparatus according to the 10^{th} aspect of the present invention, wherein said linear characteristic is equivalent to a slope amount of a straight line identified on the basis of a difference between said emission intensity at said starting time and said first sample value or a correspondent quantity corresponding to said difference and of information concerning a time difference between said starting time and said first timing or is equivalent to a slope amount that is in a correspondence relationship with said slope amount; and

said compensation control unit obtains said quantity of compensation on the basis of said emission intensity considered as said target value and said identified slope amount.

The 13^{th} aspect of the present invention is an image display method for representing a grayscale by pulse-width modulation driving of a display element, comprising:

a sampling step of obtaining emission intensity of a light source unit illuminating said display element, at a predetermined timing during a light emission period of said light source unit; and

a compensation controlling step of (i) obtaining a manner in which the emission intensity of said light source unit changes, on the basis of a first sample value obtained at a first timing in said sampling step and of a second sample value obtained at a second timing in said sampling step or a predetermined target value of said emission intensity; and (ii) controlling driving of said light source unit for compensating the emission intensity of said light source unit, on the basis of said obtained manner in which said emission intensity changes.

The 14^{th} aspect of the present invention is the image display method according to the 13^{th} aspect of the present invention, wherein, in said compensation controlling step, the manner in which said emission intensity changes is obtained on the basis of said first and second sample values.

The 15^{th} aspect of the present invention is the image display method according to the 14^{th} aspect of the present invention, wherein obtaining the manner in which said emission intensity means that a linear characteristic corresponding to a change in said emission intensity is obtained by using linear interpolation on the basis of a difference between said first and second sample values or a correspondent quantity corresponding to said difference and of information concerning a time difference between said first and second timings; and

in said compensation controlling step, a quantity of compensation for compensating said emission intensity is obtained on the basis of said obtained liner characteristic and said target value.

The 16th aspect of the present invention is the image display method according to the 15^{th} aspect of the present invention, wherein said linear characteristic is equivalent to a straight line passing through two points identified on the basis of said sample values and said timings or to a straight line that is in correspondence relationship with said straight line.

The 17^{th} aspect of the present invention is the image display method according to the 15^{th} aspect of the present invention, wherein said linear characteristic is equivalent to a slope amount of a straight line identified on the basis of a difference between said first and second sample values or a correspondent quantity corresponding to said difference and of information concerning a time difference between said first and second timings or is equivalent to a slope amount that is in a correspondence relationship with said slope amount; and

in said compensation controlling step, said emission intensity at the starting time of said emission period is considered as said target value and said quantity of compensation is obtained on the basis of said identified slope amount.

The 18^{th} aspect of the present invention is the image display method according to the 16^{th} aspect of the present invention, wherein said compensation controlling step comprises:

an error detecting step of detecting a difference between at least said first and second sample values by using all or a part of a plurality of said sample values obtained at different timings by said sampling step; and

a light source unit controlling step of controlling an electric current driving said light source unit for compensating the emission intensity of said light source unit on the basis of a result of detection at said error detecting step and information concerning said time difference.

The 19^{th} aspect of the present invention is the image display method according to the 15^{th} aspect of the present invention, wherein said compensation controlling step comprises:

a plurality of error detecting steps of detecting a difference from said target value at each of a plurality of said samplings by said sampling step;

a plurality of drive controlling steps of generating a light source driving current gain for causing the emission intensity of said light source unit to approach said target value on the basis of values detected at said plurality of error detecting steps; and

a compensation current generating step of obtaining a difference component of a light source driving current gain at each of said plurality of drive controlling steps as said correspondent quantity and generating a compensation current for compensating for a change in the emission intensity of said light source unit from said obtained difference component.

The 20^{th} aspect of the present invention is the image display method according to the 13^{th} aspect of the present invention, wherein, in said compensation controlling steps, the manner in which said emission intensity changes is obtained on the basis of said first sample value and said predetermined target value of said emission intensity.

The 21^{st} aspect of the present invention is a program for causing a computer to function as a compensation control unit of the image display apparatus according to the 1^{st} aspect of the present invention, said compensation control unit (i) obtaining a manner in which emission intensity of said light source unit, on the basis of a first sample value obtained at a first timing by said sampler and a second sample value obtained at a second timing by said sampler or a predetermined target value of said emission intensity; and (ii) controlling said light source unit driving part for compensating the emission intensity of said light source unit, on the basis of said obtained manner in which said emission intensity changes.

The 22^{nd} aspect of the present invention is a recording medium on which the program according to the 21^{st} aspect of the present invention is recorded and which is usable on a computer.

The 23^{rd} aspect of the present invention is a program for causing a computer to execute a compensation controlling step of the image display method according to the 13^{th} aspect of the present invention, said compensation controlling step (i) obtaining a manner in which the emission intensity of said light source unit changes, on the basis of a first sample value obtained at a first timing in said sampling step and of a second sample value obtained at a second timing in said sampling step or a predetermined target value of said emission intensity; and (ii) controlling driving of said light source unit for compensating the emission intensity of said light source unit, on the basis of said obtained manner in which said emission intensity changes.

The 24^{th} aspect of the present invention is a recording medium on which the program according to the 23^{rd} aspect of the present invention is recorded and which is usable on a computer.

The 25^{th} aspect of the present invention is the image display apparatus according to the 4^{th} aspect of the present invention, wherein said compensation control unit comprises:

a plurality of error detecting parts which detect a difference from said target value at each of a plurality of said samplings by said sampler;

a plurality of drive control parts which generate a light source driving current gain for causing the emission intensity of said light source unit to approach said target value on the basis of values detected by said plurality of error detecting parts; and

a compensation current generating part which obtains a difference component of a light source driving current gain of each of said plurality of drive control parts as said correspondent quantity and generates a compensation current for compensating for a change in the emission intensity of said light source unit from said obtained difference component.

The 26^{th} aspect of the present invention is the image display apparatus according to the 25^{th} aspect of the present invention, wherein said light source unit comprises red, green, and blue light emitting diodes.

The 27^{th} aspect of the present invention is the image display method according to the 16^{th} aspect of the present invention, wherein said compensation controlling step comprises:

a plurality of error detecting steps of detecting a difference from said target value at each of a plurality of said samplings by said sampling step;

a plurality of drive controlling steps of generating a light source driving current gain for causing the emission intensity of said light source unit to approach said target value on the basis of values detected at said plurality of error detecting steps; and

a compensation current generating step of obtaining a difference component of a light source driving current gain at each of said plurality of drive controlling steps as said correspondent quantity and generating a compensation current for compensating for a change in the emission intensity of said light source unit from said obtained difference component.

With this configuration, the slope of the quantity of light in the light emission period of the light source can be compensated for to achieve the continuity of grayscale representation.

### ADVANTAGE OF THE INVENTION

The image display apparatus of the present invention has the effect that grayscale levels close to predetermined grayscale levels can be achieved in spite of temporal changes in the quantity of light caused by changes in luminous efficiency due to a temperature rise of a light source during a light emission period of the light source.

### BRIEF DESCRIPTION OF THE DRAWINGS

FIG. 1 is a block diagram showing a configuration of an image display apparatus in a first embodiment of the present invention;

FIG. 2 (a) is a waveform chart illustrating the operation of the image display apparatus in the first embodiment of the present invention; FIG. 2 (b) is a waveform chart of a compensated light source driving current 570a in a second light emission period and a compensated output 105 from a light quantity detecting part in the first embodiment;

FIG. 3 is a block diagram showing a configuration of an image display apparatus in a second embodiment of the present invention;

FIG. 4 is a diagram showing a configuration of an image display apparatus in a variation of the second embodiment of the present invention;

FIG. 5 (a) is a waveform chart illustrating the operation of the image display apparatus in the variation of the second embodiment of the present invention; FIG. 5 (b) is a waveform chart of a compensated light source driving current 570a in a second light emission period and a compensated output 105 from a light quantity detecting part in the variation;

FIG. 6 is a block diagram showing a configuration of an image display apparatus in a variation of the first embodiment of the present invention;

FIG. 7 is a block diagram showing a configuration of an image display apparatus in another embodiment of the present invention;

FIG. 8 (a) is a waveform chart illustrating the operation of the image display apparatus in the embodiment shown in FIG. 7; FIG. 8 (b) is a waveform chart of a compensated light source driving current 570a in a second light emission period and a compensated output 105 from a light quantity detecting part in the embodiment shown in FIG. 7; FIG. 8 (c) is a waveform chart of a compensated light source driving current 570a in a third light emission period and a compensated output 105 from the light quantity detecting part in the embodiment shown in FIG. 7;

FIG. 9 is a block diagram showing a configuration of a conventional image display apparatus;

FIGS. 10 (a) to 10 (b) are waveform charts illustrating the operation of the conventional image display apparatus; and

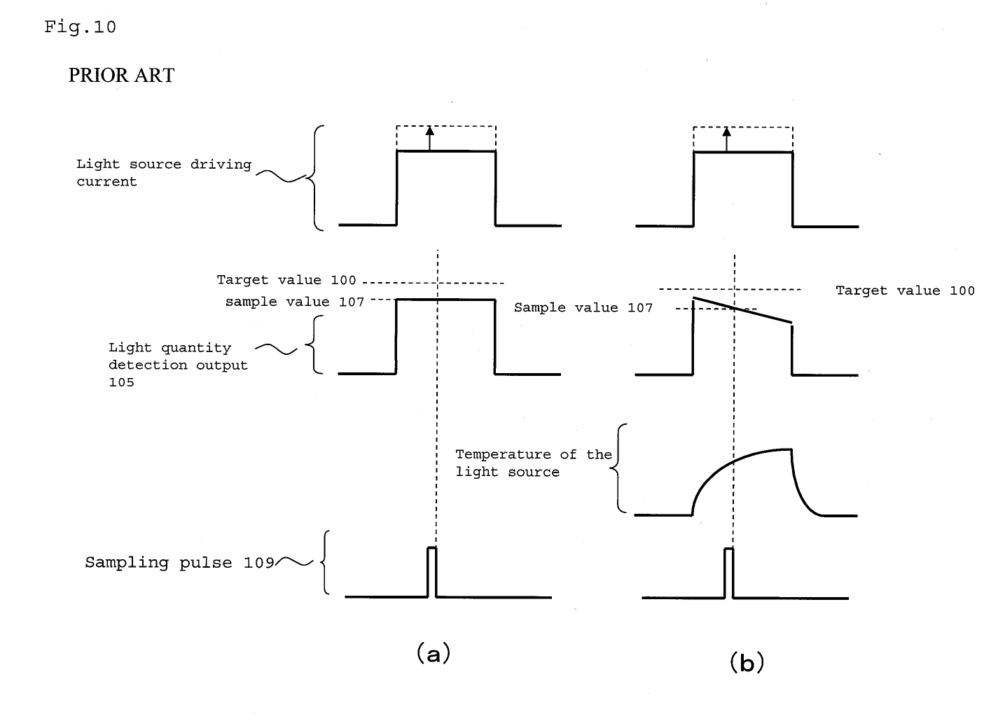

FIG. 11 is a diagram illustrating the relationship between grayscale levels and the quantity of light of the conventional image display apparatus.

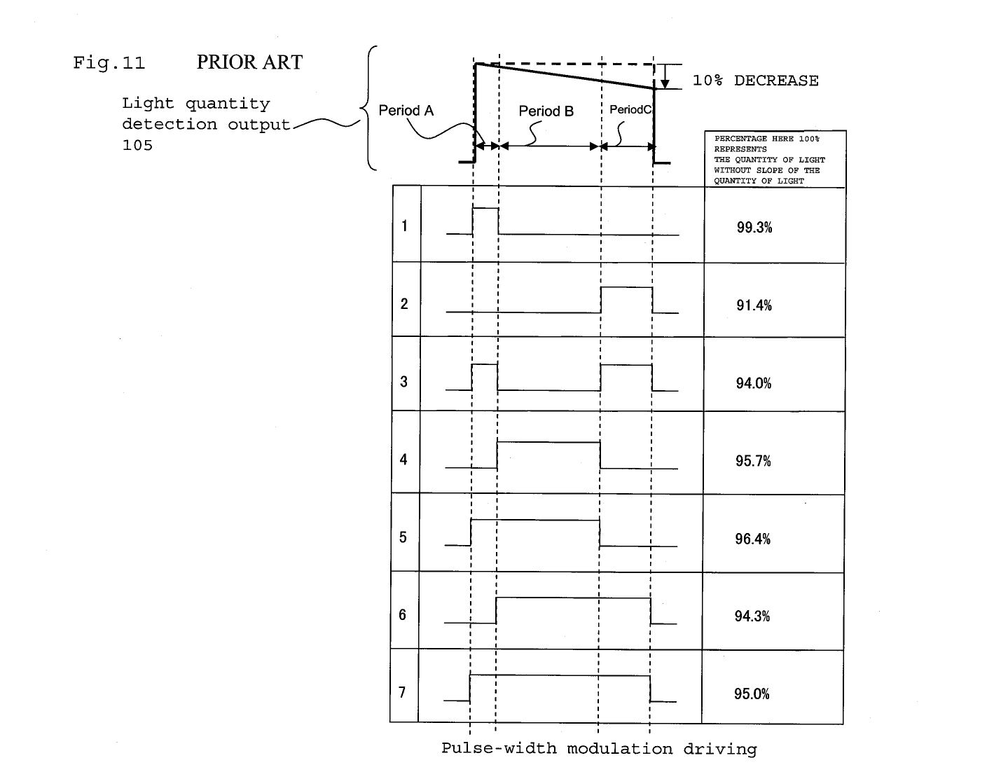

### DESCRIPTION OF SYMBOLS

50 First error detecting part
51 Second error detecting part
52 First drive control part
53 Second drive control part
54 Subtracter
55 Compensation current generating part
56 Adder
57 Light source driving part
58 Light source
59 Photodetector
60 Selector
61 AD converting part
62 Sample-and-holder
63 Timing signal generating part
65 Display element drive control part
66 Signal processing part
100 Target value
101 First sample value
102 Second sample value
103 Switching signal
104 Sampling pulse
105 Light quantity detection output
106 Input image signal
110 Light source drive timing signal
210 Detecting part for detecting difference between sample values
211 First compensation current generating part
212 Second compensation current generating part
213 Data latch part
220 First compensation current
310 Slope amount calculating part
320 Third compensation current generating part
410 Fourth compensation current generating part
412 Sample value
321, 420, 560 Total compensation current

### BEST MODE FOR CARRYING OUT THE INVENTION

Best mode for carrying out the present invention will be described with reference to the drawings.

### First Embodiment

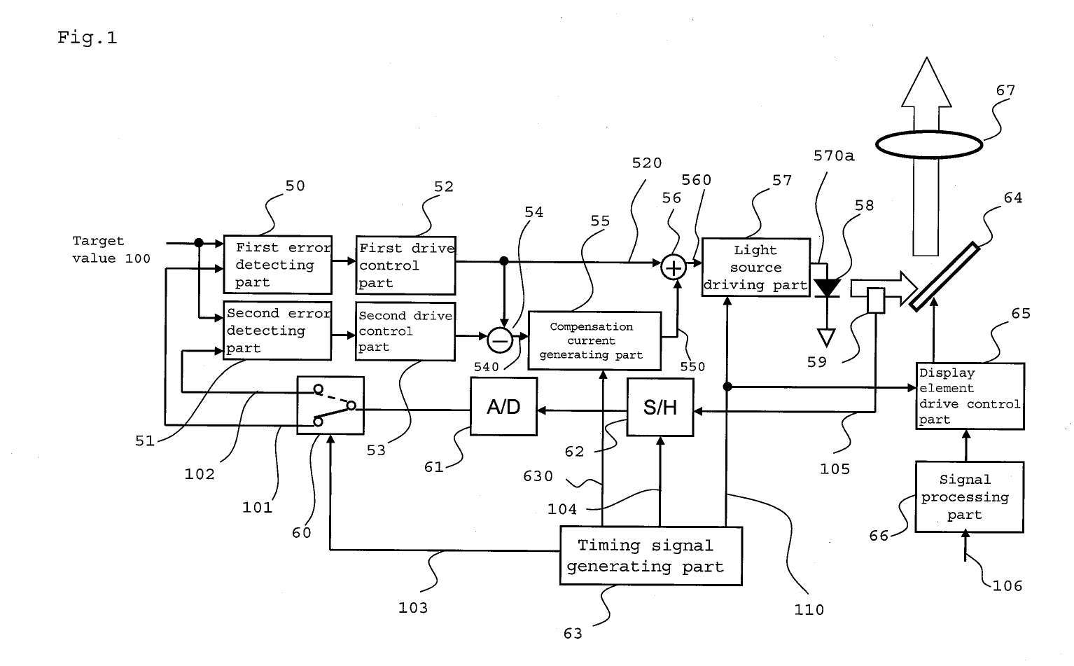

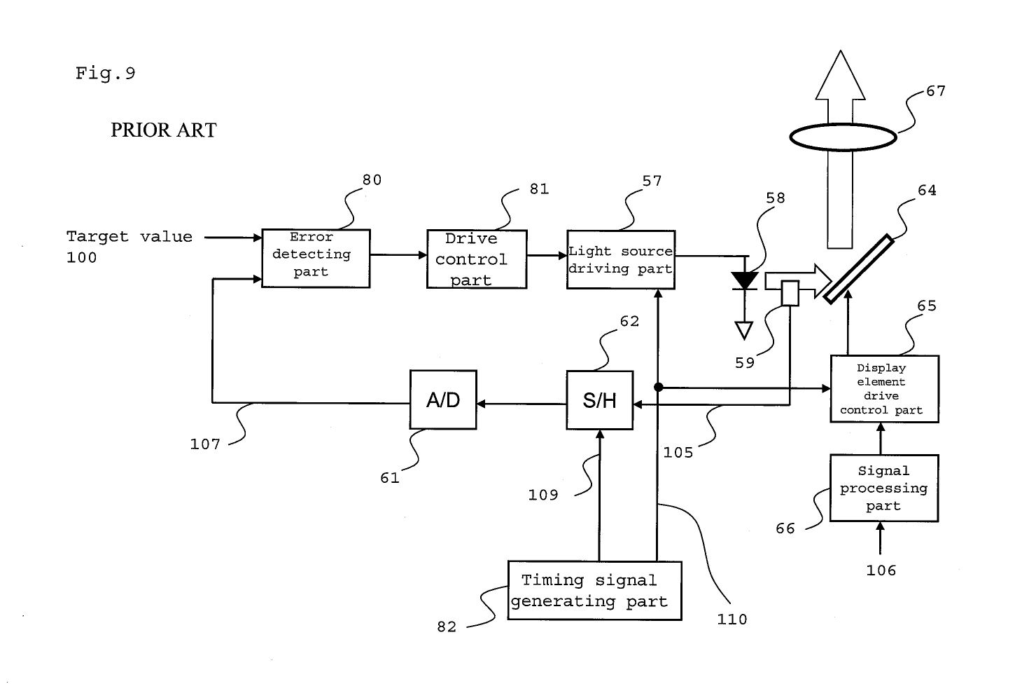

FIG. 1 is a diagram showing a configuration of an image display apparatus according to one embodiment of the present invention. In FIG. 1, the same elements as those in the example of the conventional apparatus in FIG. 9 are labeled with the same reference numerals and repeated description of which will be omitted.

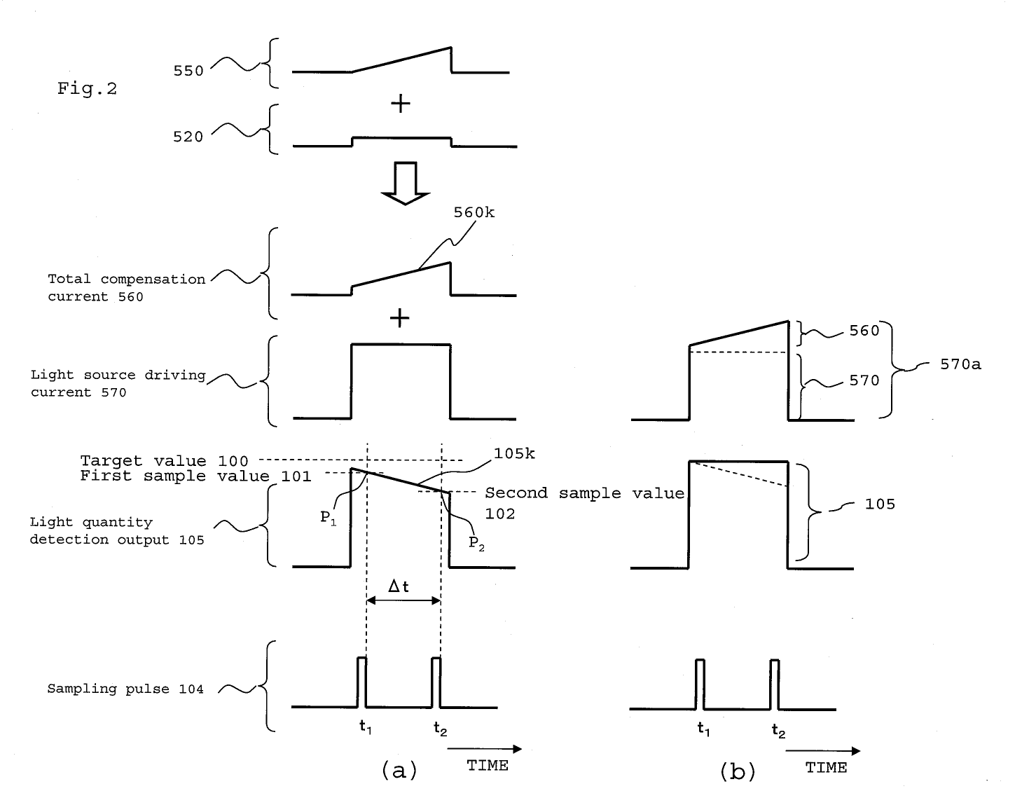

In FIG. 1, a timing signal generating part 63 generates multiple sampling pulses 104 in a light emission period of a light source 58 and also generates a switching signal 103 for a selector 60 at timings of the multiple sampling pulses 104. The timing signal generating part 63 sends timing information 630 (see t₁ and t₂ in FIG. 2 (a)) to a compensation current generating part 55.

It is assumed in the following description of the present embodiment that two sampling pulses 104 are generated in a light emission period.

The selector 60, in response to a switching signal 103, make switching so as to couple a sample value of the quantity of light obtained in response to a first sampling pulse in the sampling pulses 104 to a first sample value 101 side and to couple a sample value obtained in response to a second sampling pulse to a second sample value 102 side.

A first error detecting part 50 extracts an error component between the first sample value 101 and a predetermined target value 100. Similarly, a second error detecting part 51 extracts an error component between the second sample value 102 and the predetermined target value 100. The target value 100 is the same value for both of the first error detecting part 50 and the second error detecting part 51.

A first drive control part 52 generates a light source driving current gain for a light source driving part 57 in the direction in which the difference between the quantity of light from the light source 58 and a predetermined quantity of light decreases, that is, in the direction in which a predetermined brightness is maintained, in accordance with the error component of the sample value 101 output from the first error detecting part 50.

A second drive control part 53 generates a light source driving current gain for the light source driving part 57 in the direction in which the difference between the quantity of light from the light source 58 and the predetermined quantity of light decreases, that is, in the direction in which the predetermined brightness is maintained, in accordance with the error component of the second sample value 102 output from the second error detecting part 51.

A subtracter 54 obtains the difference component of a signal output from the first drive control part 52 and a signal output from the second drive control part 53.

A compensation current generating part 55 obtains the slope of compensation current (characteristic of a temporal change in compensation current) from an output 540 from the subtracter 54 and the time interval between first and second samplings Δt (Δt=t₂−t₁) and outputs it as a compensation current 550.

An adder 56 adds the compensation current 550 to an output 520 from the first drive control part 52.

One example of a “compensation control unit” of the present invention is a component including the first error detecting part 50, the second error detecting part 51, the first drive control part 52, the second drive control part 53, the subtracter 54, the compensation current generating part 55, and the adder 56 of the present embodiment.

One example of a “correspondent quantity corresponding to a difference between the first and second sample values” is the output 540 from the subtracter 54 of the present embodiment.

One example of “information concerning a time difference between the first and second timings” is the time interval Δt of the present embodiment.

The operation of one example of the image display apparatus according to the present invention configured as described above will be described with reference to FIGS. 1 and 2 in conjunction with one example of a method for displaying an image according to the present invention.

FIGS. 2 (a) and 2 (b) are waveform charts illustrating the operation of an image display apparatus according to an embodiment of the present invention.

As shown in FIG. 2 (a), two sampling pulses 104 are generated in the first light emission period by the timing signal generating part 63 for a light quantity detection output 105 exhibiting a slope of the quantity of light.

Sample values are obtained by the sample-and-holder 62 and the AD converting part 61 in response to sampling pulses. The sample values are separated into two sample values, a first sample value 101 and a second sample value 102, by the switching signal 103 and the selector 60.

Each of the sample values is compared with a predetermined common target value 100 and difference components are obtained at the first error detecting part 50 and the second error detecting part 51.

The compensation current generating part 55 generates a compensation current 550 from a current value difference 540 based on the two difference components and the time interval Δt between the first and second samplings by using a linear interpolation method. The compensation current 550 increases with a temporally constant slope so as to compensate for a decrease in the quantity of light that corresponds to the difference between the two sample values.

The compensation current 550 thus generated is added to the output 520 from the first drive control part 52 to obtain a total compensation current 560 shown in FIG. 2 (a).

The total compensation current 560 is added in a light emission period following the first light emission period (referred to as “the second light emission period”) to an uncompensated light source driving current 570 at the light source driving part 57. Thus, a light source driving current 570a shown in FIG. 2 (b) can be obtained.

One example of the “quantity of compensation to compensate the emission intensity” of the present invention is the total compensation current 560 of the present embodiment.

One example of the “compensation controlling step” of the image display method of the present invention is the effect and operation of a component including the first error detecting part 50, the second error detecting part 51, the first drive control part 52, the second drive control part 53, the subtracter 54, the compensation current generating part 55, and the adder 56.

By repeating the process described above as feedback control, the light quantity detection output 105 can obtain a light emission state that exhibits a flat light quantity as shown in FIG. 2 (b). As a result, discontinuity in the grayscale can be avoided and a continuous, proper grayscale representation can be achieved.

That is, the configuration described above has the effect of providing grayscale levels closer to predetermined grayscale.

While an example is shown in the present invention in which two sampling pulses 104 are generated, more than two sampling pulses may be generated. In that case, as many error detecting parts and drive control parts as the number of the sampling pulses may be provided and interpolation according to the number of the sampling pulses may be performed at the compensation current generating part.

### Second Embodiment

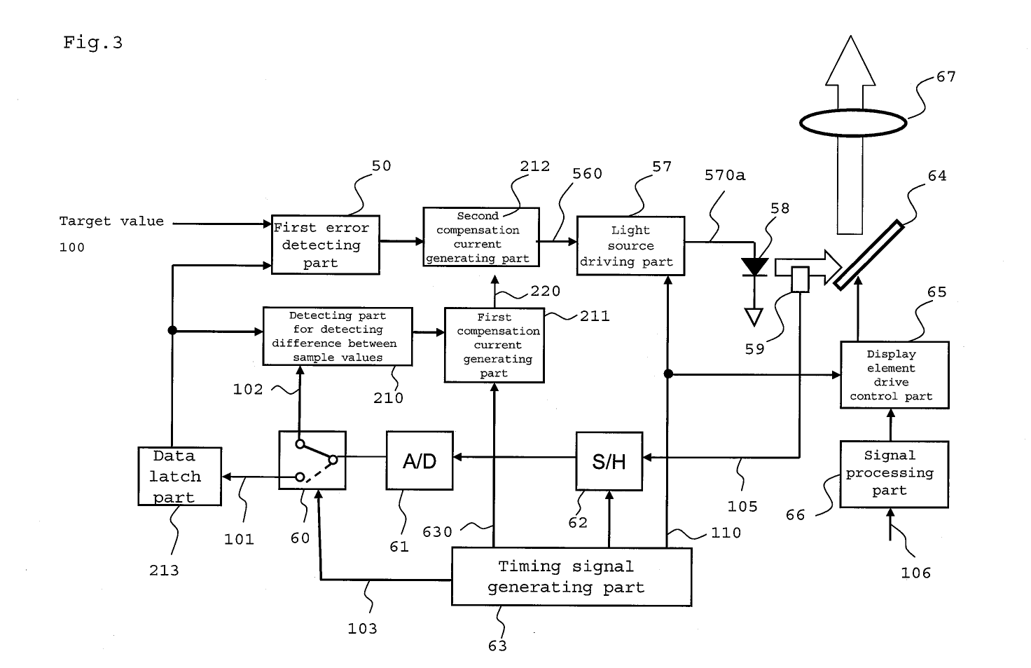

FIG. 3 is a diagram showing a configuration of an image display apparatus according to a second embodiment of the present invention. In FIG. 3, the same elements as those of the first embodiment are labeled with the same reference numerals repeated description of which will be omitted. Referring mainly to FIG. 3, the configuration will be described in conjunction with the operation of the present embodiment.

A major difference between the second embodiment and the first embodiment is that a detecting part 210 for detecting a difference between sample values, a first compensation current generating part 211, a second compensation current generating part 212, and a data latch part 213 are provided in the second embodiment.

As shown in FIG. 3, the data latch part 213 is a hold circuit that temporarily holds a first sample value 101. The detecting part 210 for detecting a difference between sample values uses the first sample value 101 held in the data latch part 213 and a second sample value 102 output from a selector 60 to detect a difference value between the two sample value and outputs it.

The first compensation current generating part 211 is an instrument which obtains a linear characteristic (first characteristic) corresponding to a temporal change in the emission intensity (the quantity of light) of a light source 58 by using the output from the detecting part 210 and sampling timing information 630 (see t₁ and t₂ in FIG. 2 (a)) from a timing signal generating part 63. The first compensation current generating part 211 is also an instrument which generates a first compensation current 220 for compensating for the temporal change in the emission intensity from the obtained linear characteristic by using a linear interpolation method. The first compensation current 220 is the same as the compensation current 550 described with respect to FIG. 1.

The liner characteristic (first characteristic) is equivalent to a straight line 105k (the line is labeled with reference symbol 105k in FIG. 2 (a) for explanation here) passing through two points P₁ and P₂ on coordinates representing a temporal change of a sample value that are identified by first and second sample values 101 and 102 and their respective timings t₁ and t₂. A straight line 560k (having a second characteristic and labeled with reference symbol 560k in FIG. 2 (a) for explanation here) that represents the first compensation current 220 obtained by linear interpolation using the straight line 105k (having the first characteristic) is in a constant correspondence relationship with the straight line 105k that the straight line 560k has a slope opposite in direction to the straight line 105k in order to achieve compensation control of the quantity of light.

The second compensation current generating part 212 has the functions of both of the first drive control part 52 and the adder 56 described with respect to FIG. 1 and outputs the same current as the total compensation current 560 described above.

The configuration described above has the same effect as the first embodiment that grayscale levels closer to predetermined grayscale levels can be provided.

One example of an “error detection unit” of the present invention is a component including the detecting part 210 for detecting a difference between sample values, the data latch part 213, and the selector 60 of the second embodiment.

One example of a “light source unit control part” of the present invention is a component including the first error detecting part 50, the first compensation current generating part 211, and the second compensation current generating part 212 of the second embodiment.

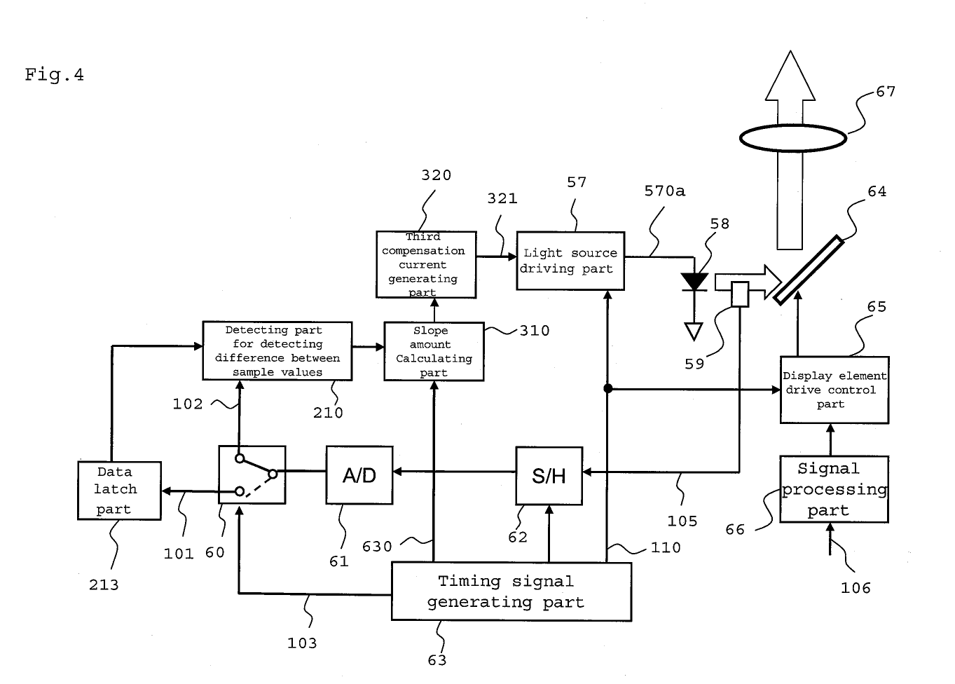

While a configuration including the first error detecting part 50 that detects an error between a first sample value and a target value 100 has been described in the second embodiment, the present invention is not so limited. For example a configuration that does not include the first error detecting part 50 may be provided as shown in FIG. 4. FIG. 4 is a diagram showing a variation of the second embodiment, in which the components as those in FIG. 3 are labeled with the same reference numerals and repeated description of which will be omitted.

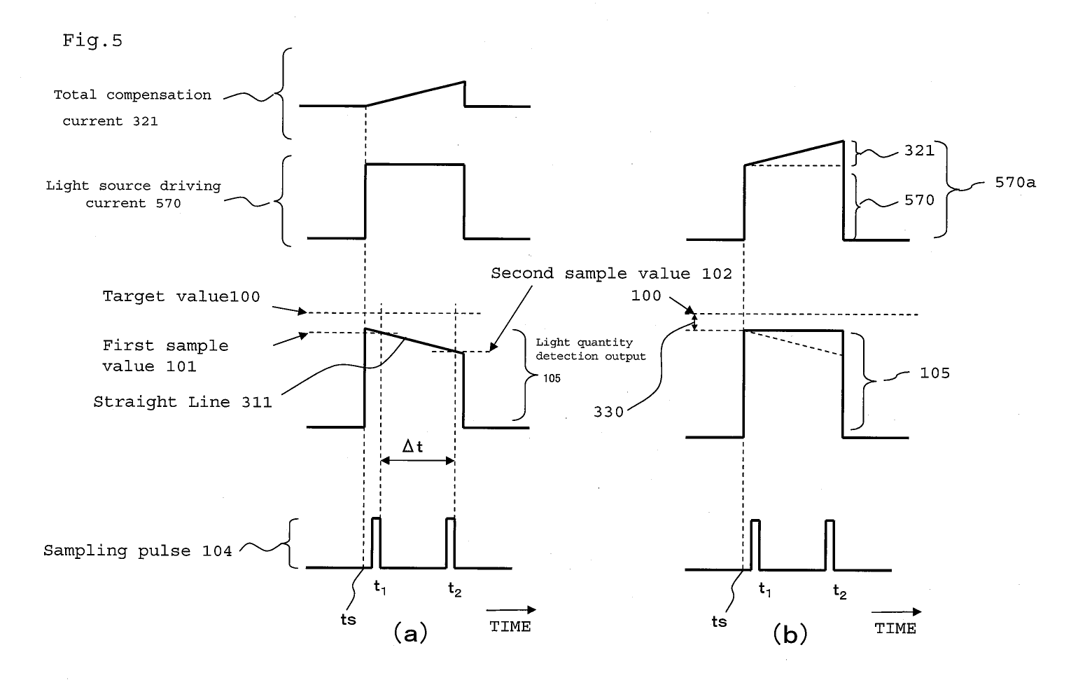

A slope amount calculating part 310 in FIG. 4 uses an output from the detecting part 210 for detecting a difference between sample values and timing information 630 (see timings t₁ and t₂ in FIG. 5 (a)) from the timing signal generating part 63 to calculate the slope amount of a straight line 311 shown in FIG. 5 (a) and outputs the slope amount.

A third compensation current generating part 320 considers that the quantity of light (emission intensity) of the light source 58 at the starting time ts of a light emission period (see FIG. 5 (a)) agrees with a target value and obtains a slope amount β that is in a constant correspondence relationship with the slope amount α (negative value) of the straight line 311. The third compensation current generating part 320 uses the slope amount β to generate a total compensation current 321 by linear interpolation for compensating the quantity of light from the light source 58 in the direction in which the difference between the quality of light and a predetermined quantity of light decreases, that is, in the direction in which predetermined brightness is maintained, and outputs the total compensation current 321 to the light source driving part 57.

The constant correspondence relationship is a correspondence relationship for compensating the quantity of light of the light source 58. That is, the slope amounts α and β are negative and positive values, respectively, and their absolute values are adjusted on the basis of constant proportionality expressed by |α|=k|β|, for example, in order to compensate the quantity of light from the light source 58. Here, k is a predetermined constant.

Since the quantity of light from the light source 58 at the starting time ts of the light emission period is considered to agree with the target value 100 in the configuration in FIG. 4 as described above, the value of the total compensation current 321 at the starting time ts is zero (see FIG. 5 (b)). The configuration described above is effective especially when the quantity of light from the light source at the starting time well agrees with the target value 100.

On the other hand, if the actual quantity of light of the light source 58 at the starting time ts does not agrees with the target value, the difference 330 between the quantity of light and the target value remains in the light emission period following the first light emission period (see FIG. 5 (b)). However, the quantity of light from the light source is temporally stabilized and therefore the effect is obtained that the continuity of grayscale levels can be achieved. In this case, the difference 330 between the actual quantity of light at the starting time ts and the target value can be reduced or eliminated by predicting the difference 330 between the actual quantity of light at the starting time ts and the target value during the design phase, for example, and adding a certain value to the total compensation current 321 (see the adder 56 in FIG. 1).

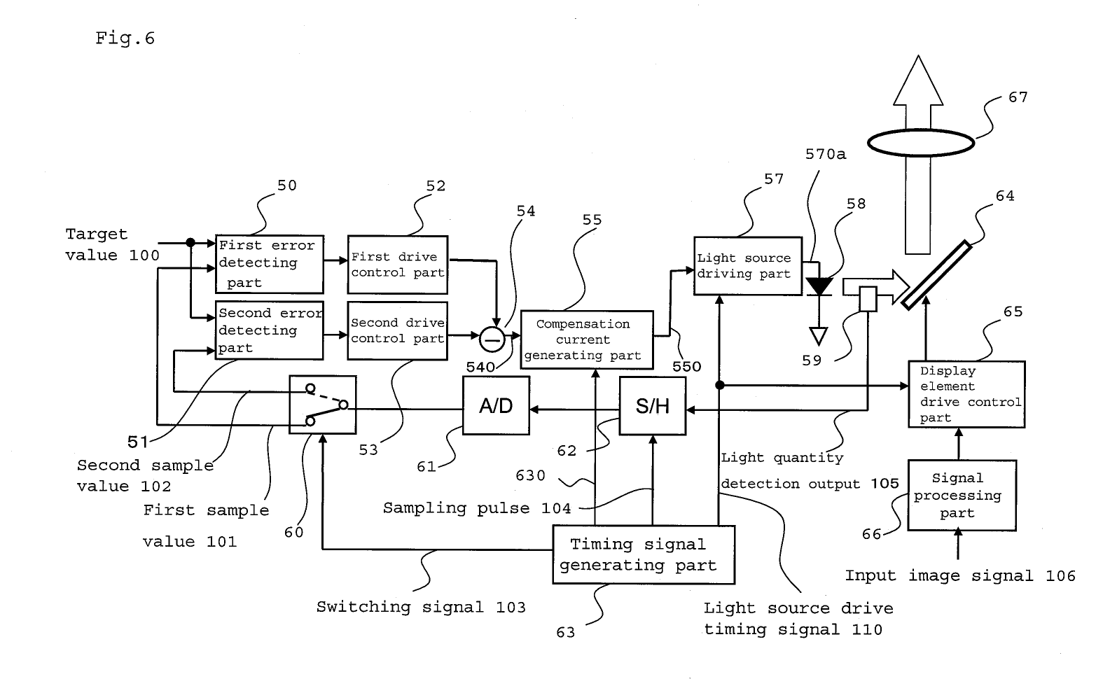

While the first embodiment described earlier includes the adder 56 that adds the output 520 from the first drive control part 52 and the output 550 from the compensation current generating part 55 together, the present invention is not so limited. A configuration that does not include the adder 56 as shown in FIG. 6 may be provided. FIG. 6 is a diagram showing a variation of the first embodiment, in which the components as those in FIG. 1 are labeled with the same reference numerals and repeated description of which will be omitted.

While the current 550 output from the compensation current generating part 55 is input in the light source driving part 57 as an input current, the output 520 from the first drive control part 52 shown in FIG. 1 is not. Accordingly, a difference between a first sample value 101 and the target value 100 will result in a difference between the compensation current 550 (see FIG. 6) and the total compensation current 560 (see FIG. 1). Thus, the difference between the quantity of light and the target value 100 remains. However, the quantity of light from the light source is temporally stabilized. Therefore, this configuration has the effect that the continuity of grayscale levels can be achieved. Furthermore, when the first sample value 101 well agrees with the target value 100, the effect can be achieved that the difference from the target value is eliminated.

The difference in the quantity of light described above can be reduced or eliminated by predicting the difference between the actual quantity of light at the first timing t₁ and the target value 100 during the design phase, for example, and adding a certain value to the compensation current 550 (see the adder 56 in FIG. 1).

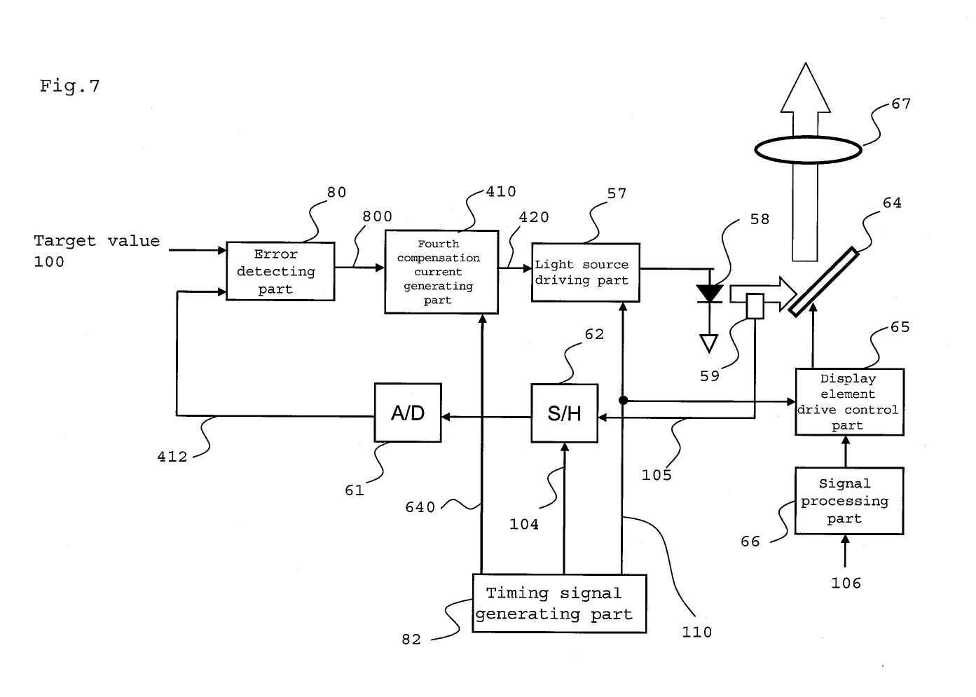

While the first and second sample values 101 and 102 are used in the embodiment described above, the present invention is not so limited. For example, a sample value 412, a target value 100, and timing information 640 may be used as shown in FIG. 7 to obtain the manner in which the emission intensity of the light source 58 changes.

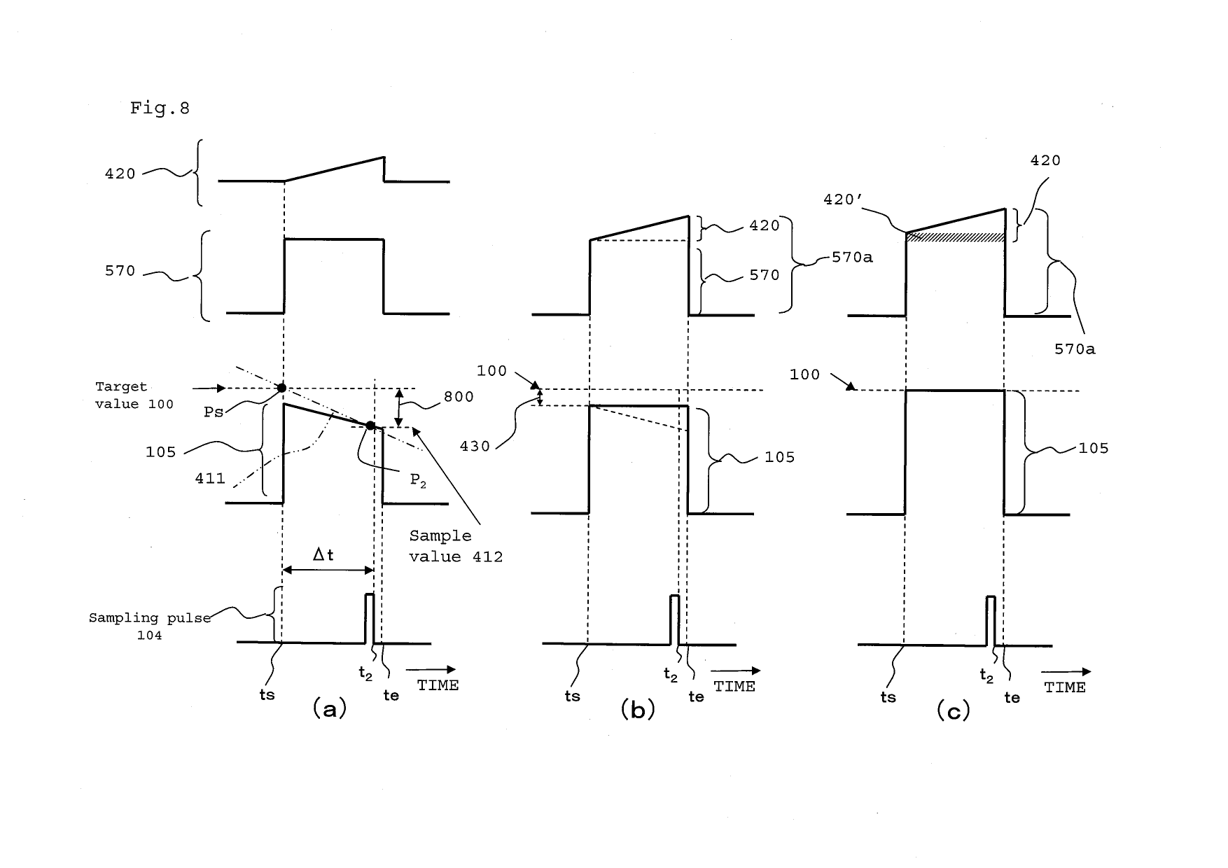

A fourth compensation current generating part 410 shown in FIG. 7 uses an output from an error detecting part 80 and timing information 640 (see FIG. 7) including the starting time ts of a light emission period of the light source 58 and the timing t₂ of second sampling, which is output from a timing signal generating part 82, as inputs in the first light emission period (see FIG. 8 (a)) to generate and output a total compensation current 420 for making the quantity of light of the light source 58 close to a target value 100 (see FIG. 8 (a)).

In the exemplary configuration in FIG. 7, it is considered that the quantity of light from the light source 58 at the starting time ts of the light emission period agrees with the target value 100.

Therefore, the fourth compensation current generating part 410 obtains the slope amount α of a straight line 411 (indicated by the chain double-dashed line in FIG. 8) from the difference 800 between a sample value and the target value that is output from an error detecting part 80 and the time interval At between the starting time ts and timing t₂. The fourth compensation current generating part 410 also obtains the slope amount β (positive value) that is in a constant correspondence relationship with the slope amount α (negative value) and generates a total compensation current 420 for compensating for a difference between the quantity of light of the light source 58 and a predetermined quantity of light in the direction in which the difference decreases, that is, in the direction in which predetermined brightness is maintained, and outputs the total compensation current 420 to a light source driving part 57.

The constant correspondence relationship here is a correspondence relationship for compensating the quantity of light of the light source 58 described with respect to FIG. 5 (a) and the slope amounts α and β are in relation expressed by |α|=k|β| as described above, therefore repeated description of which will be omitted.

In the configuration in FIG. 7, the value of the total compensation current 420 at the starting time ts that is applied in the light emission period (referred to as the second light emission period) that follows the first light emission period is always zero (see FIG. 8 (b)) because the quantity of light from the light source 58 at the starting time ts of the light emission period is considered to agree with the target value as described above.

Therefore, the sample value 412 in the second light emission period in which the total compensation current 420 is applied (see FIG. 8 (b)) is substantially temporally stable compared with the sample value in the first light emission period. However, when the actual quantity of light from the light source 58 at the starting time does not agree with the target value 100, a difference 430 from the target value (see FIG. 8 (b)) still remains.

Therefore, when the fourth compensation current generating part 410 detects a difference 430 in the quantity of light at timing t₂ in the second light emission period (see FIG. 8 (b)), an additional compensation current 420′ is generated in order to eliminate the difference 430 in the quantity of light. The fourth compensation current generating part 410 outputs a total compensation current 420 including the generated additional compensation current 420′ to the light source driving part 57 in the next, third light emission period (see FIG. 8 (c)).

This has the effect that the continuity of grayscale levels can be achieved, because the quantity of light 105 of the light source 58 agrees with the target value 100 and is temporally stabilized.

If the linear interpolation mentioned above can be applied, it is preferable that sampling timing t₂ is as close to the end time tₑ of the light emission period as possible because the slope amount a of the straight line 411 becomes closer to a real slope amount. In this case, one sampling may be sufficient in the light emission period of the light source.

In the embodiment described with respect to FIG. 7, the slope amount ac of the straight line 411 (see FIG. 8 (a)) is obtained to obtain a linear characteristic corresponding to a change in emission intensity in order to determine the manner in which the quantity of light from the light source changes. However, the present invention is not so limited. For example, a linear characteristic (first characteristic) equivalent to a straight line passing two points (see symbols Ps and P₂ in FIG. 8 (a)) that are identified by the target value 100 and a sample value 412 may be obtained and then a linear characteristic (second characteristic) required for generating the total compensation current 420 that is in a constant correspondence relationship with the obtained linear characteristic may be obtained. With this configuration, the total compensation current 420 for compensating for a difference between the quantity of light of the light source 58 and a predetermined quantity of light in the direction in which the difference decreases, that is, in the direction in which predetermined brightness is maintained, is generated and the total compensation current 420 is output to the light source driving part 57.

As an example of “obtaining the manner in which the emission intensity changes” in the present invention, a case has been described in the second embodiment in which a linear characteristic corresponding to a change in emission intensity is obtained on the basis of the difference between first and second sample values (for example, the output from the detecting part 210 for detecting a difference between sample values) and information concerning the time difference between the first and second timings (for example the time interval Δt).

On the other hand, another example has been described in the first embodiment 1 in which a linear characteristic corresponding to a change in emission intensity is obtained on the basis of a correspondent quantity corresponding to the difference between first and second sample values (for example the output 540 from the subtracter 54) and information concerning the time difference between first and second timings (for example time interval Δt).

While the first and second embodiments differ from each other in the process of obtaining a compensation current as described above, the ultimately generated total compensation currents 560 (see FIGS. 1 and 3) are the same.

In the first and second embodiments, a case has been described in which sample values at two different timings are used to compensate for a temporal change in the emission intensity of the light source. However, the present invention is not so limited. A single sample value and a target value may be used to compensate for a temporal change in the emission intensity of the light source as shown in the embodiment explained by using FIGS. 7 and 8.

In the embodiments described above, a linear characteristic (first characteristic) is obtained on the basis of the difference between sample values and the time difference between first and second timings and a linear characteristic (second characteristic) that is in a constant correspondence relationship with the linear characteristic for generating a compensation current is obtained by linear interpolation. However, the present invention is not so limited. For example, a linear characteristic (second characteristic) for generating a compensation current may be obtained on the basis of an output 540 from the subtracter 54i which is an example of a correspondent quantity corresponding to the difference between the sample values, and the time difference between the first and second timings by using linear interpolation (for example as in the first embodiment).

While the slope amount a of a straight line is obtained and then a slope amount β is obtained on the basis of the slope amount a in the embodiments described above, the present invention is not so limited. For example, the slope amount β for generating a compensation current may be obtained on the basis of an output 540 from the subtracter 54, which is an example of a correspondent quantity corresponding to the difference between the two samples, and the time difference between the first and second timings, provided that linear interpolation is used.

While two samplings are used in the embodiments described above, the present invention is not so limited. For example, three or more samplings may be used. In this case, the quantity of light can be compensated more accurately by generating a compensation current between two adjacent samplings in a manner similar to that in the embodiments described above.

While the embodiments have been described with respect to a case in which all sample values at multiple samplings are used, the present invention is not so limited. For example, some of the sample values obtained by multiple samplings may be used.

While interpolation in the compensation current generating part 55, for example, is linear interpolation in the embodiments described above, other interpolation method may be used. For example, an interpolation method may be used that uses an approximate expression obtained from a curve of measured changes in the quantity of light obtained by measuring changes in light intensity (changes in the emission intensity) of a light source under given conditions (for example conditions simulating a use environment) beforehand in the design phase of the image display apparatus.

While the embodiments have been described with respect to a case where a single light source is used, the present invention is not limited to this. For example, a combination of light emitting diodes that emit three luminescent colors, R (Red), G (Green), and B (Blue), may be used. In this case, the three color light emitting diodes repeatedly turn on and off in turn during one frame period using a field sequential system. Therefore, the configuration of the present invention is applicable to color light emitting diodes.

One example of a program of the present invention causes a computer to function as the compensation control unit (a configuration including the first error detecting part 50, the second error detecting part 51, the first drive control part 52, the second drive control part 53, the subtracter 54, the compensation current generating part 55, and the adder 56) of an image display apparatus according to any of the embodiments described above and cooperates with the computer.

Another example of a program of the present invention causes a computer to executes the compensation controlling step (equivalent to the effects and operations of a component including the first error detecting part 50, the second error detecting part 51, the first drive control part 52, the second drive control part 53, the subtracter 54, the compensation current generating part 55, and the adder 56) of the image display method for an image display apparatus according to any of the embodiments described above and cooperates with the computer.

A recording medium of the present invention is a recording medium on which a program is recorded that causes a computer to execute all or a part of the functions of the compensation control unit of an image display apparatus according to any of the embodiments described above and the computer-readable program read by the computer cooperates with the computer to execute the operation described above.

A recording medium of the present invention is a recording medium on which a program is recorded that causes a computer to execute all or a part of the operation of the compensation controlling step and the computer-readable program read by the computer cooperates with the computer to execute the operation described above.

A “part of the functions” in the recording medium described above means one or more of the multiple functions. A “part of the operations” in the recording medium described above means one or more of the multiple functions.

The “functions of the unit” in the recording medium described above manes all or a part of the functions of the unit. The “operation of the step” in the recording medium described above means all or a part of the operation of the step.

One application of the program of the present invention may be an implementation that is computer-readable, recorded on a recording medium such as a ROM and cooperates with a computer.

One application of the program of the present invention may an implementation that is transmitted through a transmission medium such as the Internet or a transmission medium such as light or a radio or sound wave, is read by a computer, and cooperates with the computer.

The computer described above may include not only pure hardware such as a CPU and other components but also firmware and an operating system, and may further include peripheral equipment.

As described above, the configuration according to the present invention may be implemented by software or hardware.

### INDUSTRIAL APPLICABILITY

The image display apparatus, image display method, program, and recording medium according to the present invention enable the continuity of grayscale levels to be maintained even when the luminous efficiency of the light source changes due to a rise in the temperature of the light source and therefore are useful as an image display apparatus and such, having an illuminating light source and driving a display element by pulse-width modulation.

1. An image display apparatus which represents a grayscale by pulse-width modulation driving of a display element, comprising:
a light source unit which illuminates said display element;
a light source unit driving part which drives said light source unit;
a photodetector which detects emission intensity of light emitted from said light source unit;
a sampler which obtains said emission intensity of said light source unit by said photodetector at a predetermined timing in a light emission period of said light source unit; and
a compensation control unit which (i) obtains a manner in which the emission intensity of said light source unit changes, on the basis of a first sample value obtained at a first timing by said sampler and of a second sample value obtained at a second timing by said sampler or a predetermined target value of said emission intensity; and (ii) controls said light source unit driving part for compensating the emission intensity of said light source unit, on the basis of said obtained manner in which said emission intensity changes.

2. The image display apparatus according to claim 1, wherein said compensation control unit obtains the manner in which said emission intensity changes, on the basis of said first and second sample values.

3. The image display apparatus according to claim 2, wherein obtaining the manner in which said emission intensity changes means that a linear characteristic corresponding to a change in said emission intensity is obtained by using linear interpolation on the basis of a difference between said first and second sample values or a correspondent quantity corresponding to said difference and of information concerning a time difference between said first and second timings; and
said compensation control unit obtains a quantity of compensation for compensating said emission intensity on the basis of said obtained linear characteristic and said target value.

4. The image display apparatus according to claim 3, wherein said linear characteristic is equivalent to a straight line passing through two points identified on the basis of said sample values and said timings or to a straight line that is in correspondence relationship with said straight line.

5. The image display apparatus according to claim 3, wherein said linear characteristic is equivalent to a slope amount of a straight line identified on the basis of a difference between said first and second sample values or a correspondent quantity corresponding to said difference and of information concerning a time difference between said first and second timings or is equivalent to a slope amount that is in a correspondence relationship with said slope amount; and
said compensation control unit considers said emission intensity at the starting time of said emission period as said target value and obtains said quantity of compensation on the basis of said identified slope amount.

6. The image display apparatus according to claim 4, wherein said compensation control unit comprises:
an error detection unit which uses all or a part of a plurality of said sample values obtained at different timings by said sampler to detect a difference between at least said first and second sample values; and
a light source unit control part which controls an electric current in said light source unit driving part for compensating the emission intensity of said light source unit on the basis of a result of detection by said error detection unit and information concerning said time difference.

7. The image display apparatus according to claim 3, wherein said compensation control unit comprises:
a plurality of error detecting parts which detect a difference from said target value at each of a plurality of said samplings by said sampler;
a plurality of drive control parts which generate a light source driving current gain for causing the emission intensity of said light source unit to approach said target value on the basis of values detected by said plurality of error detecting parts; and
a compensation current generating part which obtains a difference component of a light source driving current gain of each of said plurality of drive control parts as said correspondent quantity and generates a compensation current for compensating for a change in the emission intensity of said light source unit from said obtained difference component.

8. The image display apparatus according to claim 7, wherein said light source unit comprises red, green, and blue light emitting diodes.

9. The image display apparatus according to claim 1, wherein said compensation control unit obtains the manner in which said emission intensity changes, on the basis of said first sample value and said predetermined target value of said emission intensity.

10. The image display apparatus according to claim 9, wherein obtaining the manner in which said emission intensity changes means that said emission intensity at the starting time of said light emission period is considered as said target value and a linear characteristic corresponding to a change in said emission intensity is obtained by using linear interpolation on the basis of said target value and said first sample value; and
said compensation control unit obtains a quantity of compensation for compensating said emission intensity on the basis of said obtained linear characteristic and said target value.

11. The image display apparatus according to claim 10, wherein said linear characteristic is equivalent to a straight line passing through two points identified on the basis of said emission intensity at said starting time and said first sample value and of said starting timing and said first timing or is equivalent to a straight line that is in a correspondence relationship with said straight line.

12. The image display apparatus according to claim 10, wherein said linear characteristic is equivalent to a slope amount of a straight line identified on the basis of a difference between said emission intensity at said starting time and said first sample value or a correspondent quantity corresponding to said difference and of information concerning a time difference between said starting time and said first timing or is equivalent to a slope amount that is in a correspondence relationship with said slope amount; and
said compensation control unit obtains said quantity of compensation on the basis of said emission intensity considered as said target value and said identified slope amount.

13. An image display method for representing a grayscale by pulse-width modulation driving of a display element, comprising:
a sampling step of obtaining emission intensity of a light source unit illuminating said display element, at a predetermined timing during a light emission period of said light source unit; and
a compensation controlling step of (i) obtaining a manner in which the emission intensity of said light source unit changes, on the basis of a first sample value obtained at a first timing in said sampling step and of a second sample value obtained at a second timing in said sampling step or a predetermined target value of said emission intensity; and (ii) controlling driving of said light source unit for compensating the emission intensity of said light source unit, on the basis of said obtained manner in which said emission intensity changes.

14. The image display method according to claim 13, wherein, in said compensation controlling step, the manner in which said emission intensity changes is obtained on the basis of said first and second sample values.

15. The image display method according to claim 14, wherein obtaining the manner in which said emission intensity means that a linear characteristic corresponding to a change in said emission intensity is obtained by using linear interpolation on the basis of a difference between said first and second sample values or a correspondent quantity corresponding to said difference and of information concerning a time difference between said first and second timings; and
in said compensation controlling step, a quantity of compensation for compensating said emission intensity is obtained on the basis of said obtained liner characteristic and said target value.

16. The image display method according to claim 15, wherein said linear characteristic is equivalent to a straight line passing through two points identified on the basis of said sample values and said timings or to a straight line that is in correspondence relationship with said straight line.

17. The image display method according to claim 15, wherein said linear characteristic is equivalent to a slope amount of a straight line identified on the basis of a difference between said first and second sample values or a correspondent quantity corresponding to said difference and of information concerning a time difference between said first and second timings or is equivalent to a slope amount that is in a correspondence relationship with said slope amount; and
in said compensation controlling step, said emission intensity at the starting time of said emission period is considered as said target value and said quantity of compensation is obtained on the basis of said identified slope amount.

18. The image display method according to claim 16, wherein said compensation controlling step comprises:
an error detecting step of detecting a difference between at least said first and second sample values by using all or a part of a plurality of said sample values obtained at different timings by said sampling step; and
a light source unit controlling step of controlling an electric current driving said light source unit for compensating the emission intensity of said light source unit on the basis of a result of detection at said error detecting step and information concerning said time difference.

19. The image display method according to claim 15, wherein said compensation controlling step comprises:
a plurality of error detecting steps of detecting a difference from said target value at each of a plurality of said samplings by said sampling step;
a plurality of drive controlling steps of generating a light source driving current gain for causing the emission intensity of said light source unit to approach said target value on the basis of values detected at said plurality of error detecting steps; and
a compensation current generating step of obtaining a difference component of a light source driving current gain at each of said plurality of drive controlling steps as said correspondent quantity and generating a compensation current for compensating for a change in the emission intensity of said light source unit from said obtained difference component.

20. The image display method according to claim 13, wherein, in said compensation controlling steps, the manner in which said emission intensity changes is obtained on the basis of said first sample value and said predetermined target value of said emission intensity.

21. A program for causing a computer to function as a compensation control unit of the image display apparatus according to claim 1, said compensation control unit (i) obtaining a manner in which emission intensity of said light source unit, on the basis of a first sample value obtained at a first timing by said sampler and a second sample value obtained at a second timing by said sampler or a predetermined target value of said emission intensity; and (ii) controlling said light source unit driving part for compensating the emission intensity of said light source unit, on the basis of said obtained manner in which said emission intensity changes.

22. A recording medium on which the program according to claim 21 is recorded and which is usable on a computer.

23. A program for causing a computer to execute a compensation controlling step of the image display method according to claim 13, said compensation controlling step (i) obtaining a manner in which the emission intensity of said light source unit changes, on the basis of a first sample value obtained at a first timing in said sampling step and of a second sample value obtained at a second timing in said sampling step or a predetermined target value of said emission intensity; and (ii) controlling driving of said light source unit for compensating the emission intensity of said light source unit, on the basis of said obtained manner in which said emission intensity changes.

24. A recording medium on which the program according to claim 23 is recorded and which is usable on a computer.

25. The image display apparatus according to claim 4, wherein said compensation control unit comprises:
a plurality of error detecting parts which detect a difference from said target value at each of a plurality of said samplings by said sampler;
a plurality of drive control parts which generate a light source driving current gain for causing the emission intensity of said light source unit to approach said target value on the basis of values detected by said plurality of error detecting parts; and
a compensation current generating part which obtains a difference component of a light source driving current gain of each of said plurality of drive control parts as said correspondent quantity and generates a compensation current for compensating for a change in the emission intensity of said light source unit from said obtained difference component.

26. The image display apparatus according to claim 25, wherein said light source unit comprises red, green, and blue light emitting diodes.

27. The image display method according to claim 16, wherein said compensation controlling step comprises:
a plurality of error detecting steps of detecting a difference from said target value at each of a plurality of said samplings by said sampling step;
a plurality of drive controlling steps of generating a light source driving current gain for causing the emission intensity of said light source unit to approach said target value on the basis of values detected at said plurality of error detecting steps; and
a compensation current generating step of obtaining a difference component of a light source driving current gain at each of said plurality of drive controlling steps as said correspondent quantity and generating a compensation current for compensating for a change in the emission intensity of said light source unit from sad obtained difference component.
